(19) United States
(12) Patent Application Publication
(10) Pub. No.: US 2023/0331195 A1
(43) Pub. Date: Oct. 19, 2023

(54) Pneumatically Powered Snow Removing Device

(71) Applicant: David Burney, Las Vegas, NV (US)

(72) Inventor: David Burney, Las Vegas, NV (US)

(21) Appl. No.: 17/720,551

(22) Filed: Apr. 14, 2022

(51) Int. Cl. B60S 3/04

(52) U.S. Cl. CPC B60S 3/047

(57) ABSTRACT

A pneumatically powered snow removing device for removing snow from atop a semitrailer includes a nozzle, which is attached to and which extends angularly from a first end of a first tube. A second tube is attached to and extends angularly from a second end of the first tube. The second tube can be grasped in one or both hands of a user distal from the first tube, enabling the user to position the nozzle above snow on a top of a semitrailer. A first coupler is attached to the second tube distal from the first tube. The first coupler is complementary to and selectively couplable to a second coupler, which is attached to an air hose extending from an air compressor. Air from the air compressor passes through the nozzle to blow the snow from the top of the semitrailer.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to snow removing devices and more particularly pertains to a new snow removing device for removing snow from atop a semitrailer. The present invention discloses a snow removing device that is engageable to an air hose extending from an air compressor, allowing a user to position a nozzle above snow on a top of a semitrailer so that air from the air compressor passes through the nozzle to blow the snow from the top of the semitrailer.

### (2) Description of Related Art Including Information disclosed under 37 CFR 1.97 and 1.98

The prior art relates to snow removing devices. Prior art snow removing devices for removing snow from semitrailers may comprise drive through deicing stations, two-handled sweeping devices, elongated raking devices, and the like. The prior art also includes a variety of devices that are attachable to the pneumatic systems of semitrucks, such as sprayers, blowers to clear debris from semitrailers, and the like. Related prior art also includes assemblies that comprise air compressors and extendable arms, such as boom trucks and concrete pumpers, for blowing snow off the roofs of buildings. What is lacking in the prior art is a snow removing device that can be held and manipulated by a user positioned on the ground proximate to a semitrailer and which utilizes compressed air to blow snow off of a top of the semitrailer.

### BRIEF SUMMARY OF THE INVENTION

An embodiment of the disclosure meets the needs presented above by generally comprising a nozzle, which is attached to and which extends angularly from a first end of a first tube. A second tube is attached to and extends angularly from a second end of the first tube. The second tube is configured to be grasped in one or both hands of a user distal from the first tube, enabling the user to position the nozzle above snow on a top of a semitrailer. A first coupler is attached to the second tube distal from the first tube. The first coupler is complementary to and selectively couplable to a second coupler, which is attached to an air hose extending from an air compressor. Air from the air compressor passes through the nozzle to blow the snow from the top of the semitrailer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto. The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a pneumatically powered snow removing device according to an embodiment of the disclosure.

FIG. 2 is an isometric perspective view of an embodiment of the disclosure.

FIG. 3 is an in-use view of an embodiment of the disclosure.

FIG. 4 is an in-use view of an embodiment of the disclosure.

### DETAILED DESCRIPTION OF THE INVENTION

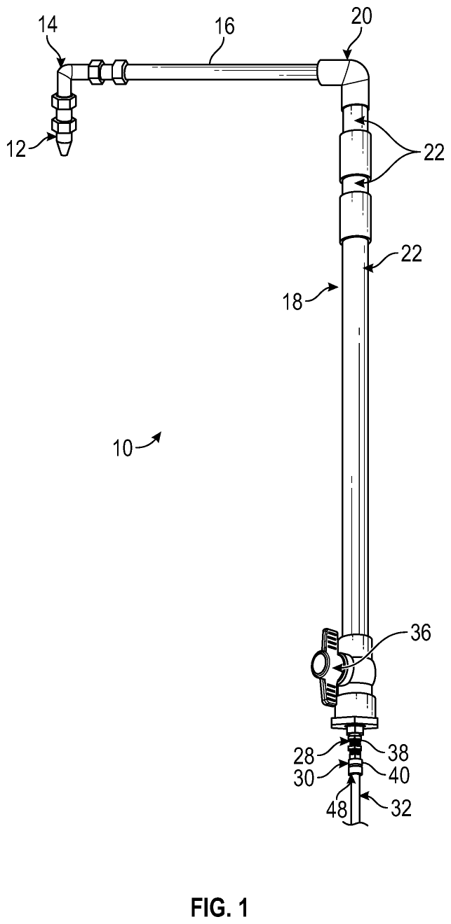

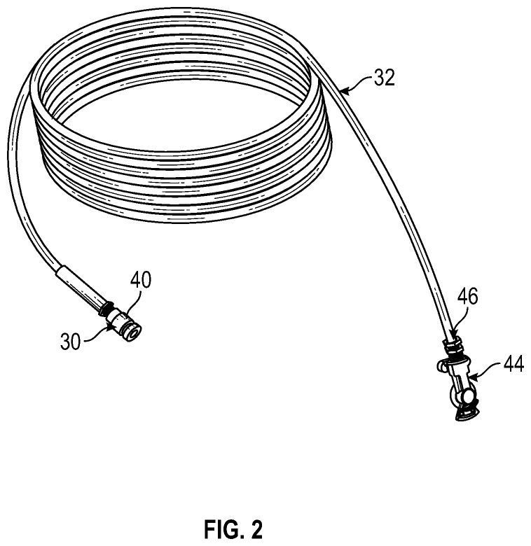

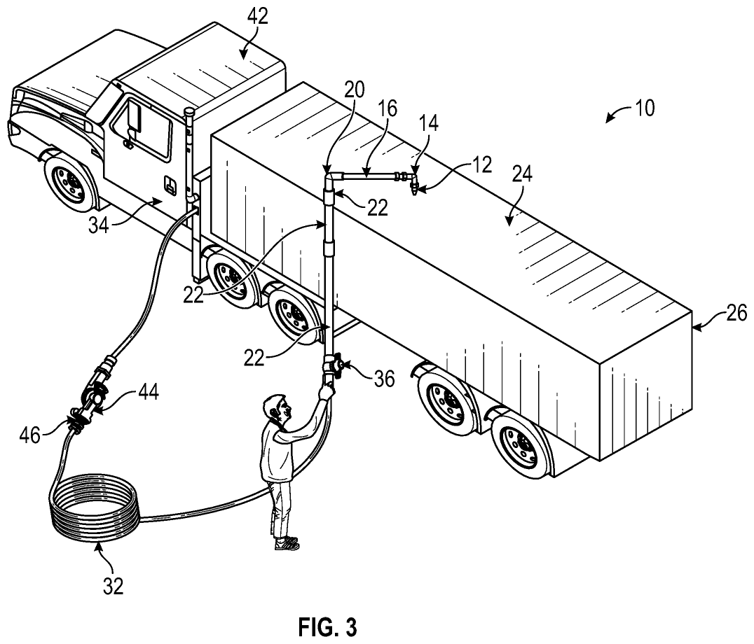

With reference now to the drawings, and in particular to FIGS. 1 through 4 thereof, a new snow removing device embodying the principles and concepts of an embodiment of the disclosure and generally designated by the reference numeral 10 will be described.

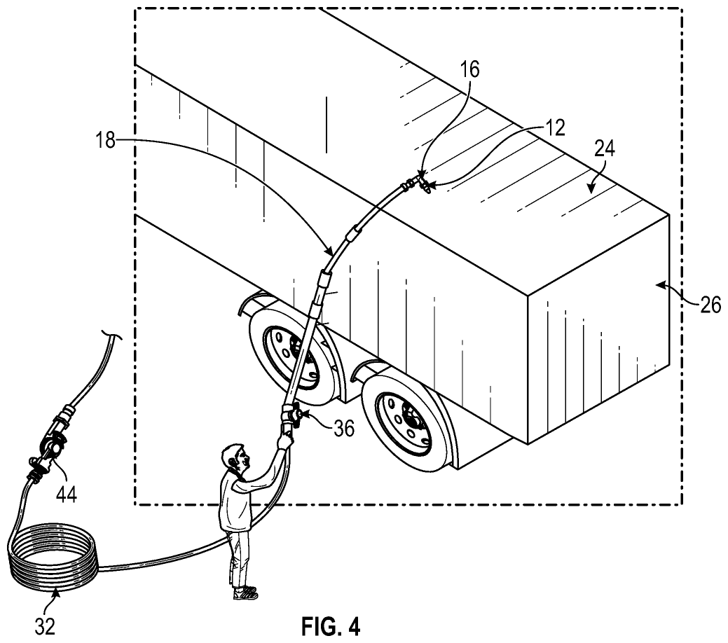

As best illustrated in FIGS. 1 through 4, the pneumatically powered snow removing device 10 generally comprises a nozzle 12, which is attached to and which extends angularly from a first end 14 of a first tube 16. A second tube 18 is attached to and extends angularly from a second end 20 of the first tube 16. The second tube 18 may comprise a plurality of nested sections 22 so that the second tube 18 is extensible. The plurality of nested sections 22 may comprise three nested sections 22, as is shown in FIG. 4, although the present invention also anticipates the plurality of nested sections 22 comprises two or four nested sections 22. The second tube 18 comprising a plurality of nested sections 22 allows for ready stowing of the pneumatically powered snow removing device 10.

The second tube 18 may comprise elastomer so that the second tube 18 is resiliently flexible. As such, the second tube 18 assumes an arcuate configuration when the nozzle 12 is positioned above the snow on the top 24 of the semitrailer 26, as shown in FIG. 4. The nozzle 12 and the second tube 18 may be at substantially 90° to the first tube 16 and may extend codirectionally from the first tube 16, as shown in FIG. 1, although the present invention anticipates other positioning of the nozzle 12 and the second tube 18 relative to the first tube 16. For example, one of the nozzle 12 or the second tube 18 may extend at 90° from the first tube 16 and the other may extend from the first tube 16 at an angle other than 90°. The nozzle 12 and the second tube 18 also could be nonplanar.

The second tube 18 is configured to be grasped in one or both hands of a user distal from the first tube 16, enabling the user to position the nozzle 12 above snow on a top 24 of a semitrailer 26. A first coupler 28 is attached to the second tube 18 distal from the first tube 16. The first coupler 28 is complementary to and selectively couplable to a second coupler 30, which is attached to an air hose 32 extending from an air compressor 34. Air from the air compressor 34 passes through the nozzle 12 to blow the snow from the top 24 of the semitrailer 26. The first coupler 28 comprises a plug 38 that is complementary to a quick change coupler 40 attached to the air hose 32. A valve 36 is positioned in the second tube 18 proximate to the first coupler 28 and is positioned to control a flow of the air into the second tube 18 to extend the nested sections 22.

In use, an air hose 32 is attached to the air compressor 34 of a semitruck 42, using a gladhand connector 44 that is attached to a first terminus 46 of the air hose 32. A quick change coupler 40, which is attached to a second terminus 48 of the air hose 32, then is attached to the plug 38 on the second tube 18. The valve 36 is slowly opened to extend the plurality of nested sections 22. The nozzle 12 then is positioned above snow on the top 24 of the semitrailer 26 hitched to the semitruck 42. Air from the air compressor 34 passes through the nozzle 12 to blow the snow from the top 24 of the semitrailer 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A pneumatically powered snow removing device comprising:
a first tube;
a nozzle attached to and extending angularly from a first end of the first tube;
a second tube attached to and extending angularly from a second end of the first tube, wherein the second tube is configured for grasping in one or both hands of a user distal from the first tube, enabling the user for positioning the nozzle above snow on a top of a semitrailer; and
a first coupler attached to the second tube distal from the first tube, the first coupler being complementary to and selectively couplable to a second coupler attached to an air hose extending from an air compressor, such that air from the air compressor passes through the nozzle for blowing the snow from the top of the semitrailer.

2. The pneumatically powered snow removing device of claim 1, further including:
the second tube comprising a plurality of nested sections, such that the second tube is extensible; and
a valve positioned in the second tube proximate to the first coupler, such that the valve is positioned to control a flow of the air into the second tube for extending the nested sections.

3. The pneumatically powered snow removing device of claim 2, wherein the plurality of nested sections comprises three nested sections.

4. The pneumatically powered snow removing device of claim 1, wherein the second tube comprises elastomer, such that the second tube is resiliently flexible and such that the second tube assumes an arcuate configuration when the nozzle is positioned above the snow on the top of the semitrailer.

5. The pneumatically powered snow removing device of claim 1, wherein the first coupler comprises a plug complementary to a quick change coupler attached to the air hose.

6. The pneumatically powered snow removing device of claim 1, wherein:
the nozzle is at substantially 90° to the first tube;
the second tube is at substantially 90° to the first tube; and
the nozzle and the second tube extend codirectionally from the first tube.

7. A pneumatically powered snow removing device system comprising:
a semitruck comprising an air compressor;
a semitrailer hitched to the semitruck;
an air hose;
a gladhand connector engaged to a first terminus of the air hose, the gladhand connector being engaged to a complementary connector attached to the air compressor;
a quick change coupler attached to a second terminus of the air hose;
a first tube;
a nozzle attached to and extending angularly from a first end of the first tube;
a second tube attached to and extending angularly from a second end of the first tube, wherein the second tube is configured for grasping in one or both hands of a user distal from the first tube, enabling the user for positioning the nozzle above snow on a top of the semitrailer; and
a plug attached to the second tube distal from the first tube, the plug being complementary to and engaged to the quick change coupler, such that air from the air compressor passes through the nozzle for blowing the snow from the top of the semitrailer.

8. The pneumatically powered snow removing device system of claim 7, further including:
the second tube comprising a plurality of nested sections, such that the second tube is extensible; and
a valve positioned in the second tube proximate to the first coupler, such that the valve is positioned to control a flow of the air into the second tube for extending the nested sections.

9. The pneumatically powered snow removing device system of claim 8, wherein the plurality of nested sections comprises three nested sections.

10. The pneumatically powered snow removing device system of claim 7, wherein the second tube comprises elastomer, such that the second tube is resiliently flexible and such that the second tube assumes an arcuate configuration when the nozzle is positioned above the snow on the top of the semitrailer.

11. The pneumatically powered snow removing device system of claim 7, wherein:
the nozzle is at substantially 90° to the first tube;
the second tube is at substantially 90° to the first tube; and
the nozzle and the second tube extend codirectionally from the first tube.

12. A pneumatically powered snow removing device comprising:
a first tube;
a nozzle attached to and extending angularly from a first end of the first tube, the nozzle being at substantially 90° to the first tube;
a second tube attached to and extending angularly from a second end of the first tube, wherein the second tube is configured for grasping in one or both hands of a user distal from the first tube, enabling the user for positioning the nozzle above snow on a top of a semitrailer, the second tube comprising a plurality of nested sections, such that the second tube is extensible, the plurality of nested sections comprising three nested sections, the second tube comprising elastomer, such that the second tube is resiliently flexible and such that the second tube assumes an arcuate configuration when the nozzle is positioned above the snow on the top of the semitrailer, the second tube being at substantially 90° to the first tube, the nozzle and the second tube extending codirectionally from the first tube;
a first coupler attached to the second tube distal from the first tube, the first coupler being complementary to and selectively couplable to a second coupler attached to an air hose extending from an air compressor, such that air from the air compressor passes through the nozzle for blowing the snow from the top of the semitrailer, the first coupler comprising a plug complementary to a quick change coupler attached to the air hose; and
a valve positioned in the second tube proximate to the first coupler, such that the valve is positioned to control a flow of the air into the second tube for extending the nested sections.
